(19) United States
(12) Patent Application Publication
(10) Pub. No.: US 2012/0110836 A1
(43) Pub. Date: May 10, 2012

(54) METHOD FOR PREPARING SECONDARY BATTERY

(75) Inventors: JeonKeun Oh, Daejeon (KR); Sang Bum Kim, Seoul (KR); Jidong Yang, Daejeon (KR)

(73) Assignee: SK INNOVATION CO., LTD., Seoul (KR)

(21) Appl. No.: 13/266,655

(22) PCT Filed: Apr. 22, 2010
(86) PCT No.: PCT/KR10/02531

§ 371 Date: Jan. 23, 2012

(30) Foreign Application Priority Data
Apr. 28, 2009 (KR) 10-2009-0036867

(51) Int. Cl. H01M 10/04; H01M 2/10

(52) U.S. Cl. 29/623.1; 29/730

(57) ABSTRACT

Provided is a secondary battery inner cell stack stacking apparatus and method that prepare a secondary battery inner cell stack of a Z-folding stacking format. To be specific, provided is a secondary battery inner cell stack stacking apparatus and method according to a method for performing multiple insertions on a plurality of anode plates and cathode plates at once in both sides after folding a separator in a zigzag shape in advance.

### TECHNICAL FIELD

The present invention relates to a secondary battery inner cell stack stacking apparatus and method, and more particularly, to a method for preparing a secondary battery inner cell stack including an anode, a cathode and a separator in a stacking type.

### BACKGROUND ART

Differently from a primary battery, researches on a chargeable and dischargeable secondary battery have been actively progressed according to development of high-tech fields including a digital camera, cellular phone, a lap-top computer, and a hybrid vehicle. Examples of the secondary battery include a nickel-cadmium battery, a nickel-metal hydride battery, a nickel-hydrogen battery, and a lithium secondary battery. FIG. 1 shows an operation principle model of a lithium battery being one of the secondary batteries. As shown in FIG. 1, the secondary battery has a format that a cathode plate, a separator, and an anode plate are sequentially stacked and steeped in an electrolyte solution.

Methods for preparing a secondary battery inner cell stack are divided into two types. In case of a small secondary battery, a method for arraying and winding the anode and cathode plates on the separator and preparing the secondary battery in a jelly-roll format is generally adopted. In case of a medium-large secondary battery having a larger capacity of electricity, a method for preparing the secondary battery by stacking the anode plate, the cathode plate and the separator in a proper order is generally used.

There are many methods for preparing the secondary battery inner cell stack in a stacking type. In a method of Z-folding called ‘Z-folding’, ‘zigzag folding’ or ‘accordion folding’ among the methods, as shown in FIG. 2, a separator 3 is folded in a zigzag shape and stacked in a format that an anode plate 1 and a cathode plate 2 are alternately inserted. The secondary battery inner cell stack of the Z-folding stacking format is disclosed in diverse related arts such as KR Patent Registration No. 0313119 and US Patent Publication No. 2005/0048361.

In order to actually realize the Z-folding stacking format, KR Patent Registration No. 0309604 discloses a method for folding the separator 3 after arraying a plurality of anode plates at one side and a plurality of anode plates at the other side of the separator. The method is widely used when the secondary battery inner cell stack of the jelly-roll format is prepared. However, when the method is used, there is a difficulty in alignment of the anode plate and the cathode plate. An apparatus shown in FIGS. 3 and 4 is conventionally used in preparing the secondary battery inner cell stack of the Z-folding stacking format.

In a method shown in FIG. 3, each of the anode plate 1 and the cathode plate 2 are stacked in individual tables separated left and right. A separator supplying device and a Z-folding stacking apparatus 10′ fold the separator 3 in a zigzag shape while moving a predetermined distance left and right, but repeat a following process. When the entire apparatus moves to the left with reference to FIG. 3, the Z-folding stacking apparatus 10′ on the left side adsorbs the anode plate 1 and maintains the state for a while. When the Z-folding stacking apparatus 10′ on the left side moves to the right and is located in a center, the Z-folding stacking apparatus 10′ on the left side arrays the anode plate 1 on the separator 3. The Z-folding stacking apparatus 10′ on the right side simultaneously adsorbs the cathode plate 2. Subsequently, when the Z-folding stacking apparatus 10′ on the right side moves to the left and is located in the center, the Z-folding stacking apparatus 10′ on the right side arrays the cathode plate 2 on the separator 3. The Z-folding stacking apparatus 10′ on the left side simultaneously adsorbs the anode plate 1 and maintains the state for a while. After the above process is repeated, the separator 3 is formed of being folded in a zigzag shape and the anode plate 1 and the cathode plate 2 are stacked in an alternately inserted format.

In a method shown in FIG. 4, in a state that the separator supplying device is fixed, each of the table having a stacked body and the Z-folding stacking apparatus 10″ performs stacking while moving in left and right directions. Except that the separator supplying device is fixed, the Z-folding stacking apparatus 10″ is operated in the manner similar to that of the Z-folding stacking apparatus 10′ in the method shown in FIG. 3. Accordingly, detailed description will not be provided herein.

The typical method may properly acquire a superior result with regard to an alignment state. However, since the layers are stacked one by one, there is a limitation that it takes a long time to complete one cell stack and productivity is remarkably reduced. Accordingly, improvement on the limitation has been requested by people having an ordinary skill in the art.

### DISCLOSURE OF INVENTION

### Technical Problem

An object of the present invention is to provide a secondary battery inner cell stack stacking apparatus and method according to a method for performing multiple insertions on a plurality of anode plates and cathode plates at once in both sides after folding a separator in a zigzag shape in advance.

### Solution to Problem

In one general aspect, a secondary battery inner cell stack stacking apparatus prepares a secondary battery inner cell stack comprising a separator folded in a zigzag shape, and an anode plate and a cathode plate that are alternately inserted and stacked in folded portions of the separator, wherein a plurality of anode plates and cathode plates are simultaneously inserted into an electrode insertion space after forming the electrode insertion space by folding the separator in the zigzag shape in advance.

The secondary battery inner cell stack stacking apparatus, may include: a separator supplying device supplying the separator in a first direction; a pair of reference rollers separately fixed and arrayed in top and bottom locations of the secondary battery inner cell stack in a first direction to guide the separator; first and second mandrel rows separately arrayed along a second direction with the separator as a center and formed to be movable in each of the second and third directions by separately arraying a plurality of mandrels at the same interval in a region between the pair of reference rollers in the first direction; and first and second electrode supplying devices separately arrayed along the second direction with the separator as a center and formed to be movable in each of the second and third directions by separately arraying the anode plates or the cathode plates at the same interval in a region between the pair of reference rollers in the first direction, wherein the second direction is a direction vertical to the first direction; and the third direction is a direction vertical to the first and second directions.

In the secondary battery inner cell stack stacking apparatus, the first electrode supplying device is arrayed in an outer side of the first mandrel row and the second electrode supplying device is arrayed in an outer side of the second mandrel row with the separator as a center in an initial location, mandrels included in the first mandrel row and mandrels included in the second mandrel row are alternately arrayed in the first direction for alternate moving of the first mandrel row and the second mandrel row in the second direction, one type of electrode plate selected from the anode plate and the cathode plate is arrayed in the first electrode supplying device in parallel with the mandrels of the first mandrel row in the first direction, and another type of electrode plate, which is not arrayed in the first electrode supplying device, is arrayed in the second electrode supplying device in parallel with the mandrels of the second mandrel row in the first direction.

The first and second mandrel rows and the first and second electrode supplying devices may be integrally formed.

In another general aspect, a secondary battery inner cell stack stacking method based on a secondary battery inner cell stack stacking apparatus, includes: forming an electrode insertion space by folding a separator in a zigzag shape; simultaneously inserting a plurality of anode plates and cathode plates into an electrode insertion space.

In still another general aspect, a secondary battery inner cell stack stacking method based on a secondary battery inner cell stack stacking apparatus, includes: supplying a separator into a region of first and second mandrel rows by a separator supplying device; alternately moving the first and second mandrel rows in a second direction to form the separator in a zigzag shape; moving first and second electrode supplying devices in the second or a third direction to insert an anode plate or a cathode plate into an electrode insertion space formed on a left and a right, respectively, by folding the separator in a zigzag shape; separating the first and second electrode supplying devices from the anode plate or the cathode plate and removing the first and second mandrel rows by moving the first and second mandrel rows in the third direction; and cutting the separator in a location of a reference roller of a top or a bottom.

The alternately moving of the first and second mandrel rows and the moving of first and second electrode supplying devices may be simultaneously performed since the first and second mandrel rows and the first and second electrode supplying devices are integrally formed, wherein in the moving of first and second electrode supplying devices, the first and second electrode supplying devices move in the second direction.

In the separating of the first and second electrode supplying devices, the first and second electrode supplying devices may move in the second or third direction and be removed.

The method may further include: after the cutting of the separator, performing a post treatment process including a pressing or heating process on a completed cell stack stacked body in the first direction.

The method may further include: after the performing of a post treatment process, welding each tab of the stacked anode plates to each other in the first direction and welding each tab of the stacked cathode plates to each other in the first direction; and enclosing and fixing a circumference of the cell stack stacked body in the first and second directions with the separator.

### Advantageous Effects of Invention

The present invention shows a large effect in essentially removing a limitation that it takes a long time to complete one cell stack in a conventional Z-folding stacking method since layers are stacked one by one. To be specific, since the present invention forms a complete body of cell stacks at one by performing multiple insertions on a plurality of anode plates and cathode plates after folding a separator in a zigzag shape in advance, a production time is remarkably reduced in comparison with the convention method.

Therefore, the present invention has economic effects that productivity of a secondary battery is maximized and a merchantable quality is improved to the maximum level by largely reducing a production cost for the secondary battery.

### BRIEF DESCRIPTION OF DRAWINGS

The above and other objects, features and advantages of the present invention will become apparent from the following description of preferred embodiments given in conjunction with the accompanying drawings, in which:

FIG. 1 shows an operation model of a general secondary battery.

FIG. 2 shows a secondary battery inner cell stack prepared according to a Z-folding stacking method.

FIGS. 3 and 4 show a conventional Z-folding stacking method.

FIG. 5 is a basic concept showing a Z-folding stacking method in accordance with an embodiment of the present invention.

FIGS. 6 to 11 show each process of a cell stack preparing method in accordance with an embodiment of the present invention.

FIG. 12 show an array of first and second electrode supplying devices, and first and second mandrel rows.

FIG. 13 shows a final process after a post treatment process in brief.

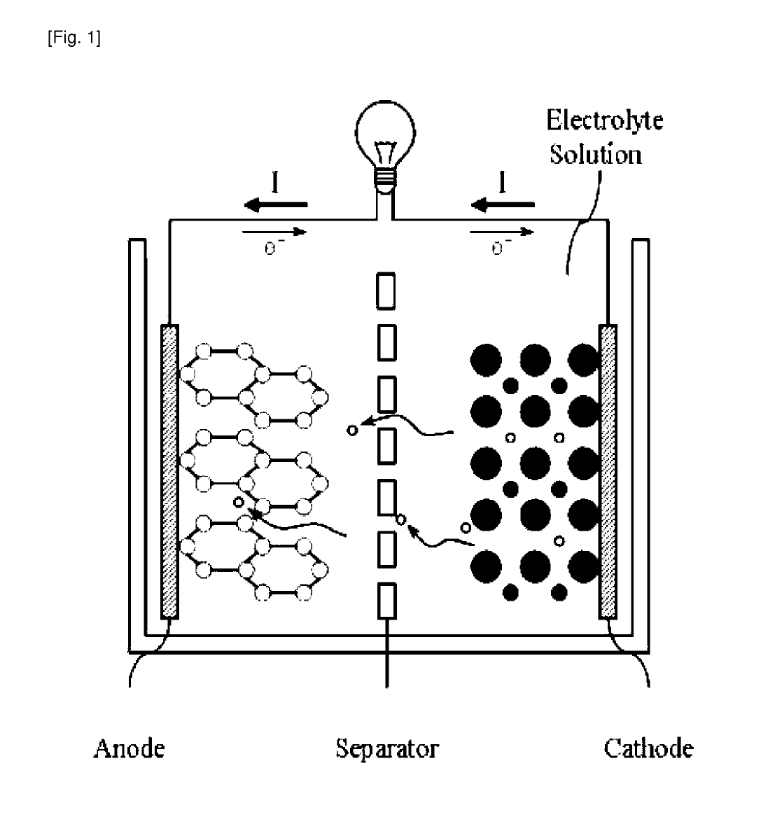

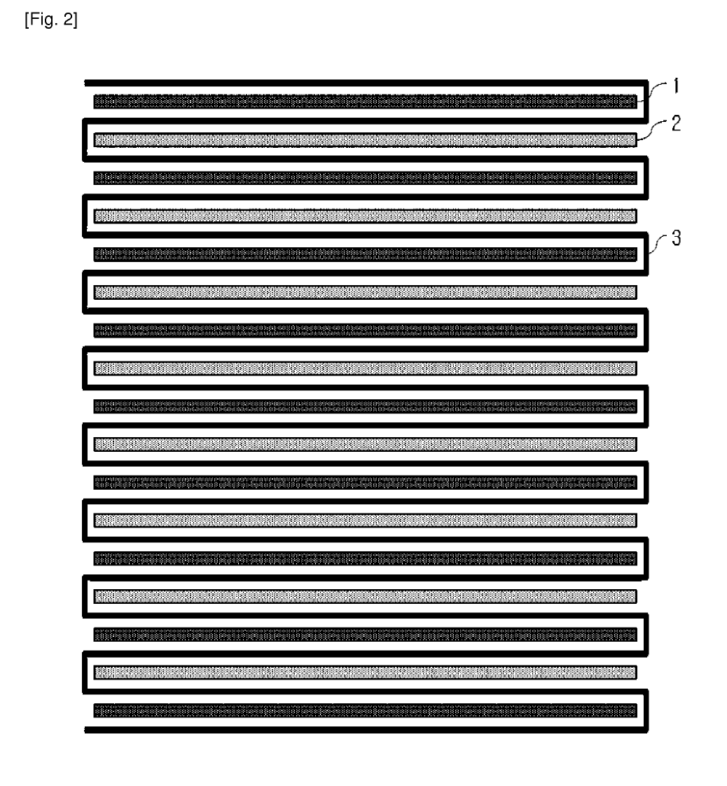

### DETAILED DESCRIPTION OF MAIN ELEMENTS

1: anode plate 2: cathode plate
3: separator
10: cell stack stacking apparatus (of the present invention)
11: reference roller
12a: first mandrel row 12b: second mandrel row
13a: first electrode supplying device
13b: second electrode supplying device

### BEST MODE FOR CARRYING OUT THE INVENTION

Hereinafter, a secondary battery inner cell stack stacking apparatus and method of the present invention will be described in detail with reference to accompanying drawings.

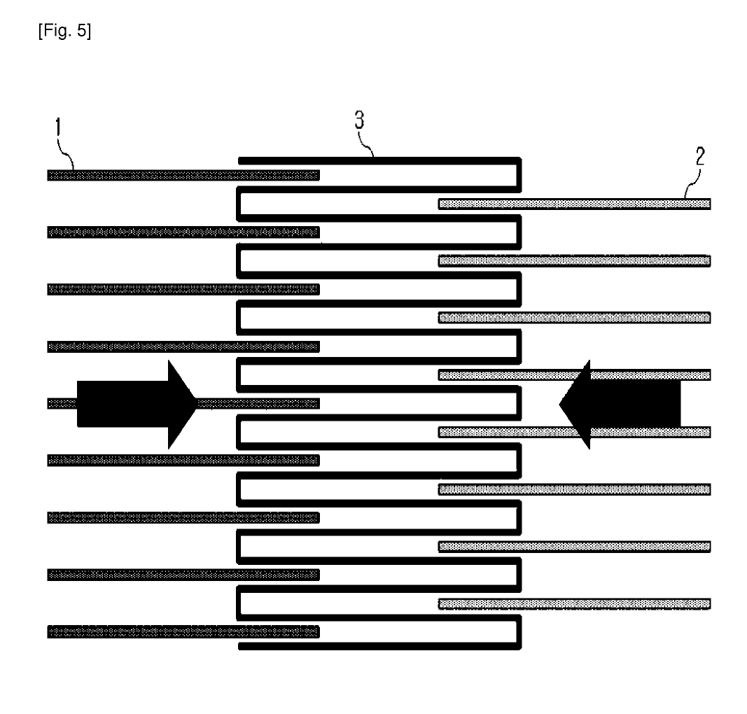

FIG. 5 shows a basic concept of the secondary battery inner cell stack stacking apparatus and method of the present invention. In the secondary battery inner cell stack stacking apparatus and method of the present invention, a plurality of anode plates 1 and cathode plates 2 are multiply inserted at once in both sides after folding a separator 3 in a zigzag shape in advance.

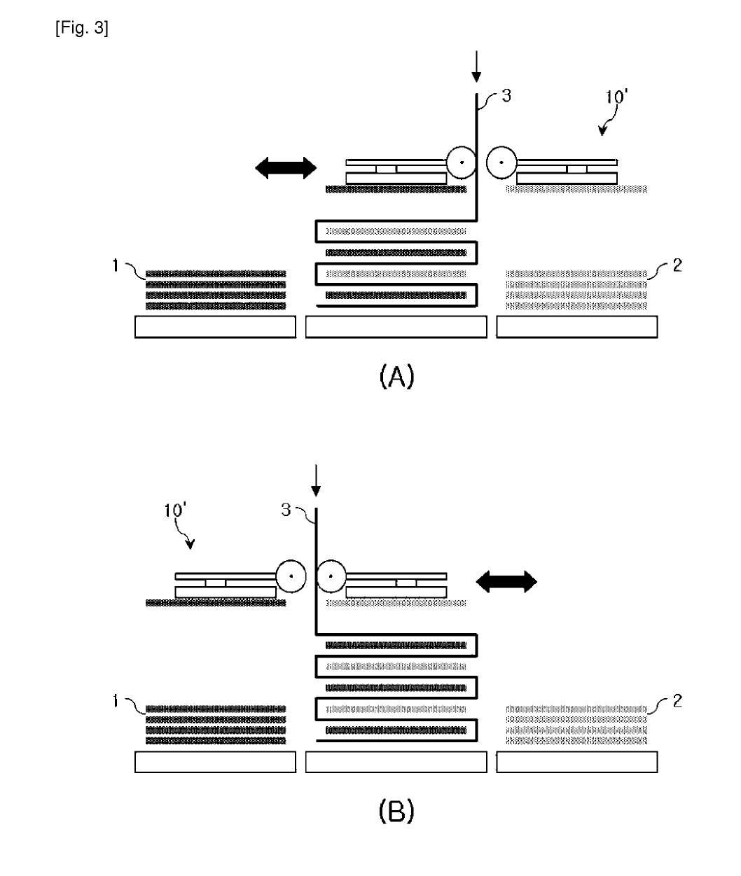

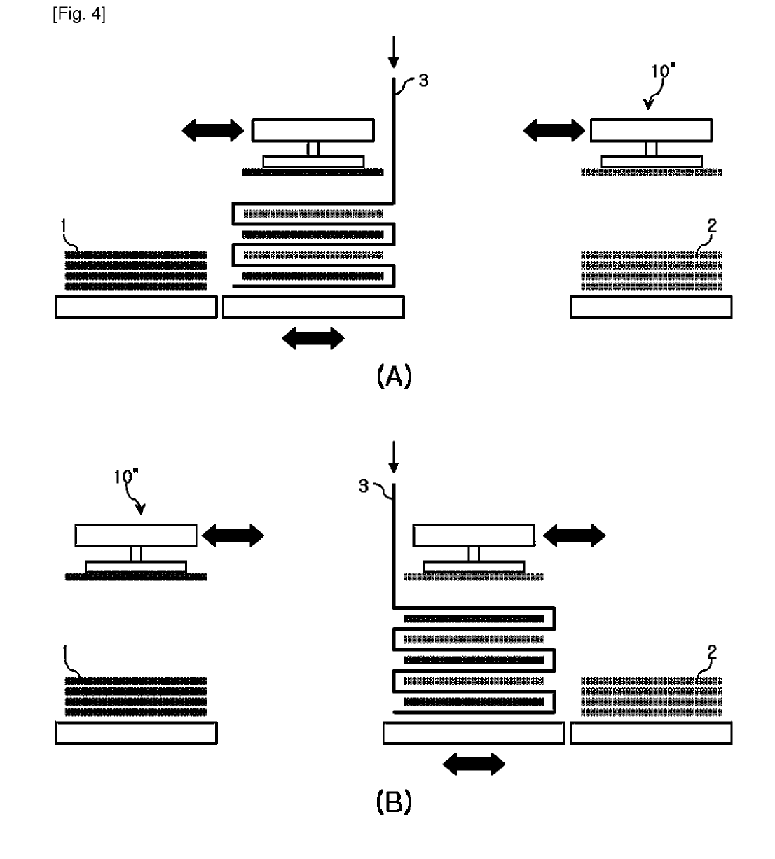

Conventionally, a cell stack is prepared by folding the separator 3 after arraying the anode plate 1 and the cathode plate 2 on the separator 3. Otherwise, as shown in FIG. 3 or 4, a cell stack is prepared by repeating a process of folding the separator 3 once, arraying the anode plate 1, folding the separator 3 again, and arraying the cathode plate 2 on the separator 3 several times, i.e., by stacking layers one by one. Accordingly, there is a difficulty in preparing electrodes having a good alignment state in the former method, i.e., the method for folding the separator after arraying the anode plate and the cathode plate on the separator. Also, there is a shortcoming that it takes a long time to complete one cell stack in the latter method, i.e., the method for stacking layers one by one.

However, the present invention may acquire a good alignment state and remarkably reduce a production time since a cell stack is prepared by inserting a plurality of electrodes at once in spaces formed in left and right sides when the separator 3 is folded in a zigzag shape, which is a format that the cell stack is completed, in advance as shown in FIG. 5.

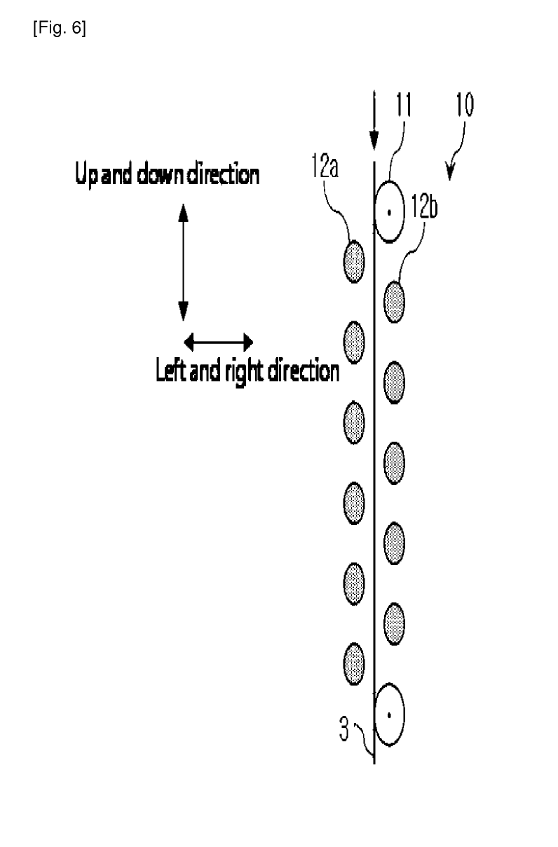

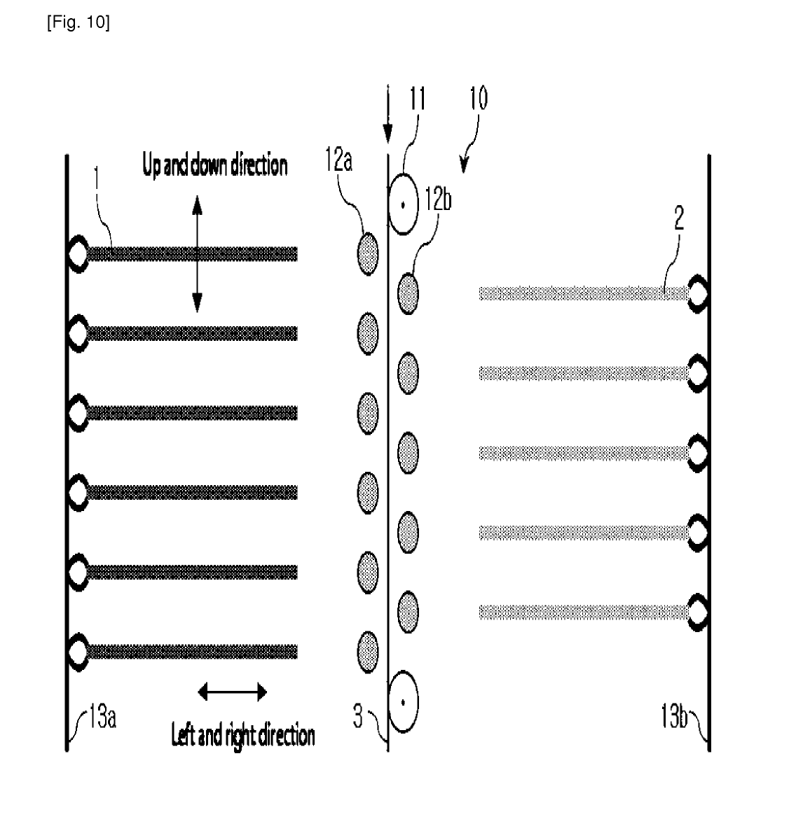

FIGS. 6 to 9 show each process of the cell stack stacking method in accordance with the present invention. The stack stacking apparatus in accordance with the present invention is schematically shown in FIG. 10 in brief.

With reference to FIG. 10, a configuration of a cell stack stacking apparatus 10 in accordance with the present invention will be described in brief. As shown in FIG. 10, the cell stack stacking apparatus 10 in accordance with the present invention includes a separator supplying device (not shown), a pair of reference rollers 11, first and second mandrel rows 12a and 12b and first and second electrode supplying devices 13a and 13b to prepare the separator 3 formed of being folded in a zigzag shape and a secondary battery inner cell stack of a format that the anode plate 1 and the cathode plate 2 are stacked by being alternately inserted into folded parts of the separator 3.

The separator supplying device supplies the separator 3 in a first direction. For example, the first direction may be an up and down direction, i.e., a gravity direction, as shown in FIGS. 6 to 12. The first direction is not limited to the up and down direction and may be properly modified by elements such as convenience in preparing. In FIGS. 6 to 12, arrows simply indicate supplying of the separator 3 by the separator supplying device. However, when the separator supplying device is actually realized, a roller and a control unit may be included in the first direction to smoothly supply the separator 3 maintaining proper tension. When the above condition is satisfied, a currently commercialized separator supplying device or separator supplying devices having any format may be used in the present invention.

In top and bottom locations of the cell stack formed by the cell stack stacking apparatus 10 of the present invention, a pair of reference rollers 11 are securely arrayed by being separated to each other in the first direction. A separated degree of the reference roller 11 is determined by a cell stack size and the separator 3 is guided to a right location by the reference roller 11.

As shown in the drawing, the first and second mandrel rows 12a and 12b are formed by separately arraying a plurality of mandrels at the same interval in the first direction in a region between a pair of reference rollers 11. The first and second mandrel rows 12a and 12b are separately arrayed in a second direction on the basis of the separator 3. The first and second mandrel rows 12a and 12b are formed to be movable to each of the second direction and a third direction. The second direction is vertical to the first direction and the third direction is vertical to the first and second directions. For example, when the first direction is an up and down direction as shown in FIGS. 6 to 12, the second direction may be a left and right direction and the third direction may be a front and rear direction. However, the example does not limit the present invention and may be modified by elements such as convenience in preparing. For example, the first, second and third directions may be up and down, front and rear, and left and right directions, respectively, or the first, second and third directions may be left and right, up and down, and front and rear directions, respectively. That is, when the first direction is determined according to the elements such as convenience in preparing, the second direction is determined as being any one of the directions vertical to the first direction and third direction is automatically determined as being a direction vertical to both of the first and second directions.

As shown in the drawing, the first and second electrode supplying devices 13a and 13b separately array a plurality of anode plates 1 or cathode plates 2 at the same interval in the first direction in the region between the pair of reference rollers 11. The first and second electrode supplying devices 13a and 13b are separately arrayed on the basis of the separator 3. The first and second electrode supplying devices 13a and 13b are formed to be movable to each of the second and third directions. When the first and second electrode supplying devices 13a and 13b move to the second direction, i.e., to the left and right direction, the first and second electrode supplying devices 13a and 13b are separately arrayed in the second direction, i.e., the left and right direction in the drawing, from the separator 3. When the first and second electrode supplying devices 13a and 13b move to the third direction, i.e., the front and rear direction in the drawing or a direction of going into a ground or coming out from the ground on the basis of the drawing, the first and second electrode supplying devices 13a and 13b are separately arrayed in parallel to the third direction, i.e., a front and rear direction in the drawing, with respect to a location of the electrode plate after completion. The first and second electrode supplying devices 13a and 13b may be formed integrally with the first and second mandrel rows 12a and 12b.

For reference, the anode plate 1 or the cathode plate 2 may be arrayed in any one of the first and second electrode supplying devices 13a and 13b. However, when the anode plate 1 is arrayed in the first electrode supplying device 13a, the cathode plate 2 is arrayed in the second electrode supplying device 13b. Reversely, when the cathode plate 2 is arrayed in the first electrode supplying device 13a, the anode plate 1 is arrayed in the second electrode supplying device 13b. That is, when any one type of electrode of the anode plate 1 and the cathode plate 2 is selectively arrayed in the first electrode supplying device 13a, the other type of electrode that is not arrayed in the first electrode supplying device 13a is arrayed in the second electrode supplying device 13b.

Initial locations and detailed array formats of the first and second mandrel rows 12a and 12b and the first and second electrode supplying devices 13a and 13b will be described in detail with description on operations according to processes of each portion with reference to FIGS. 6 to 9.

The cell stack stacking method using the cell stack stacking apparatus 10 in accordance with the present invention includes processes shown in FIGS. 6 to 9.

The initial locations and the detailed array formats will be described. At an initial stage, mandrel rows and electrode supplying devices are arrayed along the second direction. As shown in FIG. 10, the first electrode supplying device 13a is arrayed in an outer side of the first mandrel row 12a from the separator 3 and the second electrode supplying device 13b is arrayed in an outer side of the second mandrel row 12b. For example, as shown in FIG. 10, when the second direction is a left and right direction, the first electrode supplying device 13a—the first mandrel row 12a—the separator 3—the second mandrel row 12b—the second electrode supplying device 13b are arrayed according to an order from the left of the drawing. The left and the right may be switched. When the left and the right are switched, the second electrode supplying device 13b—the second mandrel row 12b—the separator 3—the first mandrel row 12a—the first electrode supplying device 13a are arrayed according to an order from the left of the drawing (not shown). The initial locations, the detailed array formats and the detailed operations will be described based on the array format shown in FIG. 10. Additional description on the case that the left and the right are switched is not provided herein since it will be understood by only changing a left and right concept in description below. As described above, the second direction may be a front and rear direction instead of the left and right direction. In this case, the third direction is not the front and rear direction but a left and right direction. Additional description on this case is not provided herein since it will be understood by only changing the left and right concept into a front and rear concept in description below. In addition, each of the first direction/the second direction/the third direction is set as the up and down/left and right/front and rear direction in the above description but may be any one of the up and down/left and right/front and rear direction, the up and down/front and rear/left and right direction, the front and rear/up and down/left and right direction, the front and rear/left and right/up and down direction, the left and right/up and down/front and rear direction, or the left and right/front and rear/up and down under a condition that the first, second and third directions are 3 axis directions vertical to one another. Additional description on the above cases is not provided herein since it will be understood by switching each direction corresponding to the first, second and third directions in the above and following descriptions.

As shown in FIGS. 6 to 11, mandrels included in the first mandrel row 12a and mandrels included in the second mandrel row 12b are alternately arrayed in the first direction for alternate moving of the first mandrel row 12a and the second mandrel row 12b in the second direction, i.e., a direction vertical to the first direction. In the example of FIGS. 6 to 11, the first direction is the up and down direction and the second direction is the left and right direction. It is most preferred that a location of each mandrel of the first mandrel row 12a and a location between the mandrels of the second mandrel row 12b are arrayed in parallel to the first direction as shown in the drawing, i.e., in the same location in the up and down direction in FIGS. 6 to 11. It is also most preferred that a location of each mandrel of the second mandrel row 12b and a location between the mandrels of the first mandrel row 12a are arrayed in parallel to the first direction, i.e., in the same location in the up and down direction in FIGS. 6 to 11. In order to alternately move the first and second mandrel rows 12a and 12b, a gap between mandrels in the first direction should be formed to be the same as or larger than a diameter of each mandrel.

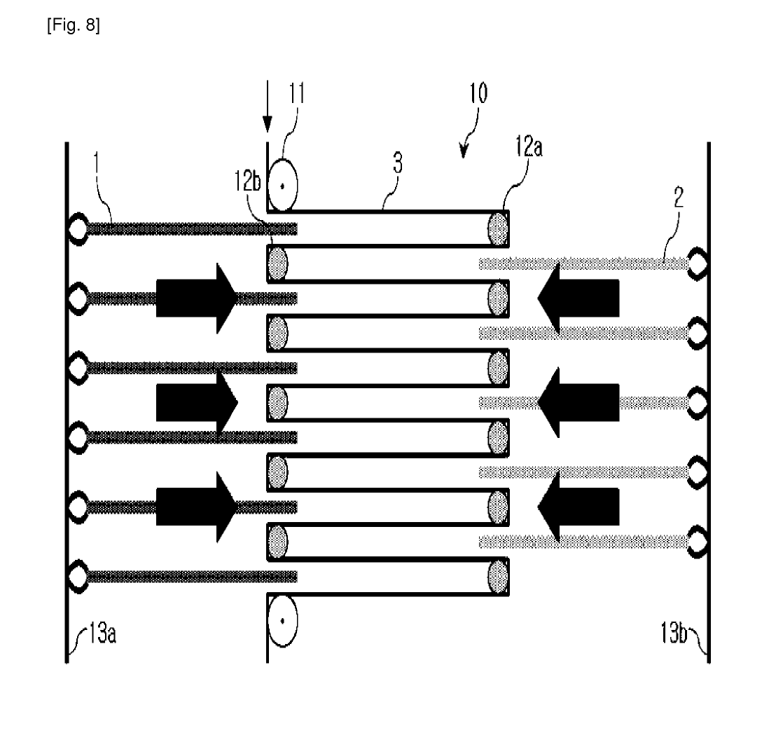

When each of the first and second mandrel rows 12a and 12b alternately move in the second direction, the separator 3 is formed of a zigzag shape and electrode insertion spaces are created. It will be described in detail hereinafter. The first and second electrode supplying devices 13a and 13b insert the anode plate 1 or the cathode plate 2 into the electrode insertion spaces. Accordingly, as shown in FIG. 8 or 10, the first electrode supplying device 13a arrayed in the outer side of the first mandrel row 12a arrays one type of electrode plate selected from the anode plate 1 or the cathode plate 2 to be parallel with the mandrels included in the first mandrel row 12a in the first direction, i.e., in the same location in the up and down direction of FIGS. 6 to 11. In the same manner, as shown in FIG. 8 or 10, the second electrode supplying device 13b arrayed in the outer side of the second mandrel row 12b arrays another type of electrode plate, which is not arrayed in the first electrode supplying device 13a, to be parallel with the mandrels included in the second mandrel row 12b in the first direction. The first and second electrode supplying devices 13a and 13b may be arrayed to be parallel with or to be alternate to the first and second mandrel rows 12a and 12b in the third direction. In either case, in the initial location, the first electrode supplying device 13a and the first mandrel row 12a are arrayed to be parallel in the first direction, i.e., in the same location in the up and down direction. Also, the second electrode supplying device 13b and the second mandrel row 12b are arrayed to be parallel in the first direction, i.e., in the same location in the up and down direction. It will be described in detail in each operation process hereinafter.

The cell stack stacking method using the cell stack stacking apparatus 10 in accordance with the present invention will be described according to each process.

As shown in FIG. 6, the separator 3 is supplied into the gap between the first and second mandrel rows 12a and 12b by the separator supplying device in process a).

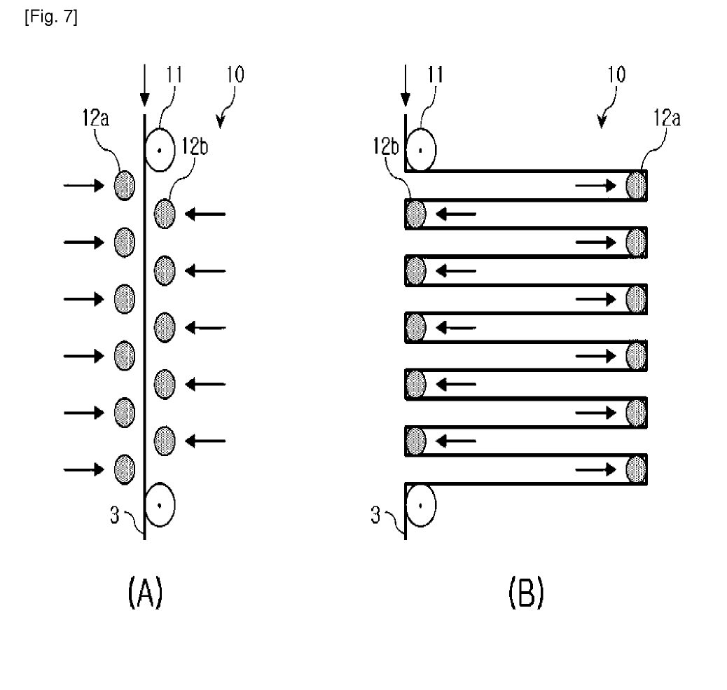

As shown in FIG. 7, in process b), the first and second mandrel rows 12a and 12b alternately move in the second direction to form the separator 3 in a zigzag shape. That is, initially on the basis of FIGS. 6 to 11, as shown in FIG. 7 (A), with the separator 3 as the center, the first mandrel row 12a is arrayed on the left of the separator 3 and the second mandrel row 12b is arrayed on the right of the separator 3. Subsequently, as shown in FIG. 7 (B), each of the first mandrel row 12a and the second mandrel row 12b alternately move to the right and the left. Since the separator 3 is arrayed between the first and second mandrel rows 12a and 12b, the first and second mandrel rows 12a and 12b alternately move to naturally form the separator 3 folded in a zigzag shape.

Since the separator supplying device enables the separator 3 to be smoothly supplied while giving proper tension to the separator 3, the separator 3 may maintain a zigzag shape at the proper tension by the pair of reference rollers 11 located in the first and second mandrel rows 12a and 12b, and the top and the bottom.

As shown in FIG. 8, in process c), the first and second electrode supplying devices 13a and 13b move in the second direction and the anode plate 1 or the cathode plate 2 are inserted into the electrode insertion space formed in the left and the right when the separator 3 is folded in the zigzag shape. The first and second electrode supplying devices 13a and 13b may move in any one of the second and third directions under a condition that the electrode plates are inserted in the electrode insertion space formed in the process b). Each case will be described in detail hereinafter.

When the first and second electrode supplying devices 13a and 13b are arrayed in parallel with the first and second mandrel rows 12a and 12b in the third direction, the first and second electrode supplying devices 13a and 13b move as follows. On the basis of FIG. 8, the first electrode supplying device 13a moves to the right and the anode plate 1 is inserted into a space generated when the first mandrel row 12a moves from the left to the right. Similarly, the second electrode supplying device 13b moves to the left and the anode plate 2 is inserted into a space generated when the second mandrel row 12b moves from the right to the left. In addition, the anode plate 1 is not necessary arrayed in the first electrode supplying device 13a. The anode plate 1 and the cathode plate 2 may be arrayed in a direction opposite to that of FIG. 8. That is, each of the first and second electrode supplying devices 13a and 13b moves in the same direction as the alternately moving direction of the first and second mandrel rows 12a and 12b. Since the first and second electrode supplying devices 13a and 13b only need to insert the electrode into the electrode insertion space of the separator 3, alternate moving is not required but moving to a location where the anode plate 1 and the cathode plate 2 are aligned is required.

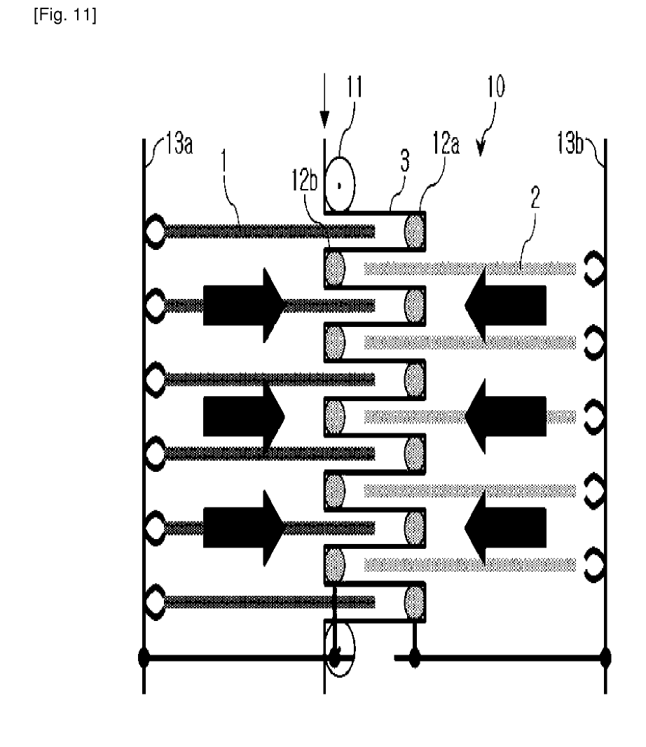

When the first and second electrode supplying devices 13a and 13b are integrally formed with the first and second mandrel rows 12a and 12b, the moving of the first and second mandrel rows 12a and 12b may be simultaneously performed with the moving of the first and second electrode supplying devices 13a and 13b as shown in FIG. 11. That is, the process b) of forming the electrode insertion space while folding the separator in the zigzag shape by alternate moving of the mandrel rows is simultaneously performed with the process c) of inserting the electrode plates into the electrode insertion space by the electrode supplying devices.

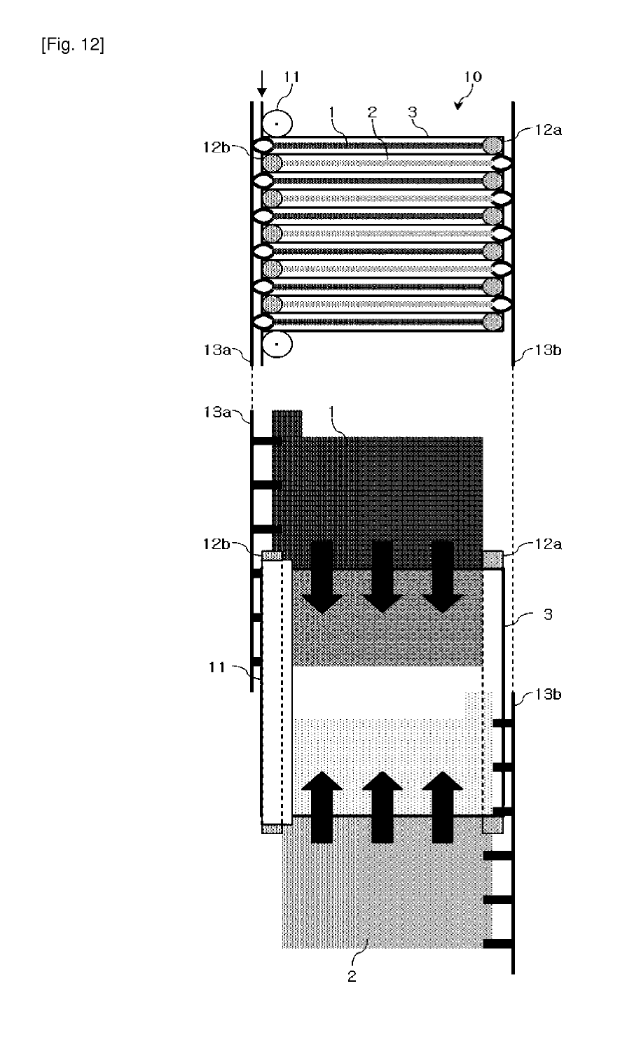

When the first and second electrode supplying devices 13a and 13b are arrayed alternately with the first and second mandrel rows 12a and 12b in the third direction, moving of the first and second electrode supplying devices 13a and 13b is as follows. This array is shown in FIG. 12 in brief. As shown in FIG. 12, the first electrode supplying device 13a may be arrayed in the rear and the second electrode supplying device 13b may be arrayed in the front. Although it is not shown, the directions may be switched. On the basis of FIG. 12, the first electrode supplying device 13a moves to the front and the second electrode supplying device 13b moves to the rear. According to this operation, the electrode plate may be inserted into the electrode insertion space formed in the process b).

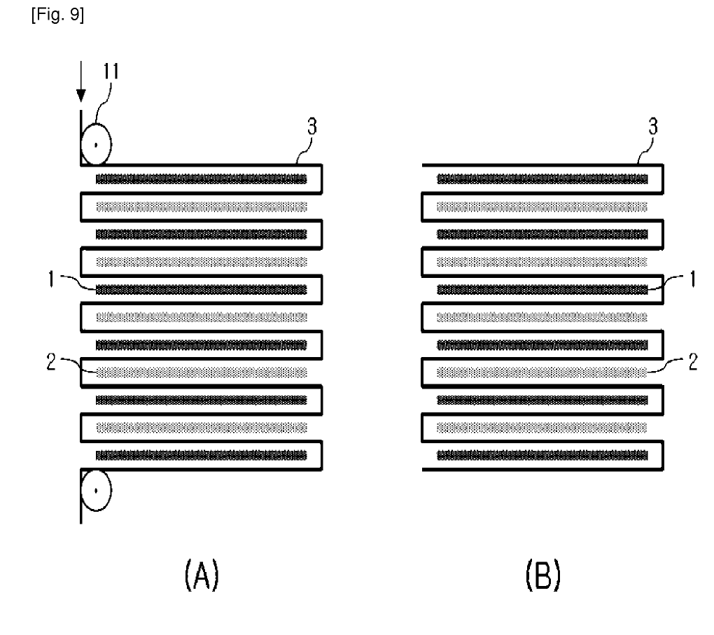

When the anode plate 1 and the cathode plate 2 are inserted into and arrayed in the electrode insertion space of the separator 3 folded in the zigzag shape by the first and second electrode supplying devices 13a and 13b, the first and second mandrel rows 12a and 12b and the first and second electrode supplying devices 13a and 13b are removed. As shown in FIG. 9 (A), in process d), the first and second electrode supplying devices 13a and 13b are divided from the anode plate 1 or the cathode plate 2 and the first and second mandrel rows 12a and 12b are removed by moving in the third direction, i.e., a direction vertical to the first and second directions. In the example of FIGS. 6 to 11, the first, second and third directions are respectively an up and down direction, a left and right direction, and a front and rear direction. The first and second electrode supplying devices 13a and 13b release portions holding the anode plate 1 or the cathode plate 2, respectively go back in the left and right direction or the front and rear direction, i.e., the second or third direction, and return to the initial location. The first and second mandrel rows 12a and 12b become free from the separator 3 by moving to the front or rear, i.e., a direction of going into a ground or coming out from the ground on the basis of FIG. 8.

Since the first and second mandrel rows 12a and 12b should be removed without damaging the separator 3, the first and second mandrel rows 12a and 12b are removed by moving in the front and rear direction on the basis of FIG. 8, i.e., the third direction. However, since the first and second electrode supplying devices 13a and 13b do not have such a restriction, the first and second mandrel rows 12a and 12b may be removed by moving in either of the left and right direction or the front and rear direction, i.e., the second direction or the third direction. In all cases, moving in other directions except the above-mentioned examples according to reasons such as convenience in preparing may be further included. Since it is relevant to design change of a person having an ordinary skill in the art, detailed description will not be provided.

As shown in FIG. 9 (B), in process e), a cell stack prepared according to the Z-folding stacking method is completed by cutting the separator 3 in the location of the reference roller 11 of the top or the bottom. After the process e), a post treatment process including processes for pressing or heating a cell stack stacked body, which is completed through the processes a) to e), in the first direction may be further performed in process f). Since it may be determined properly according to products or materials, detailed description will not be provided.

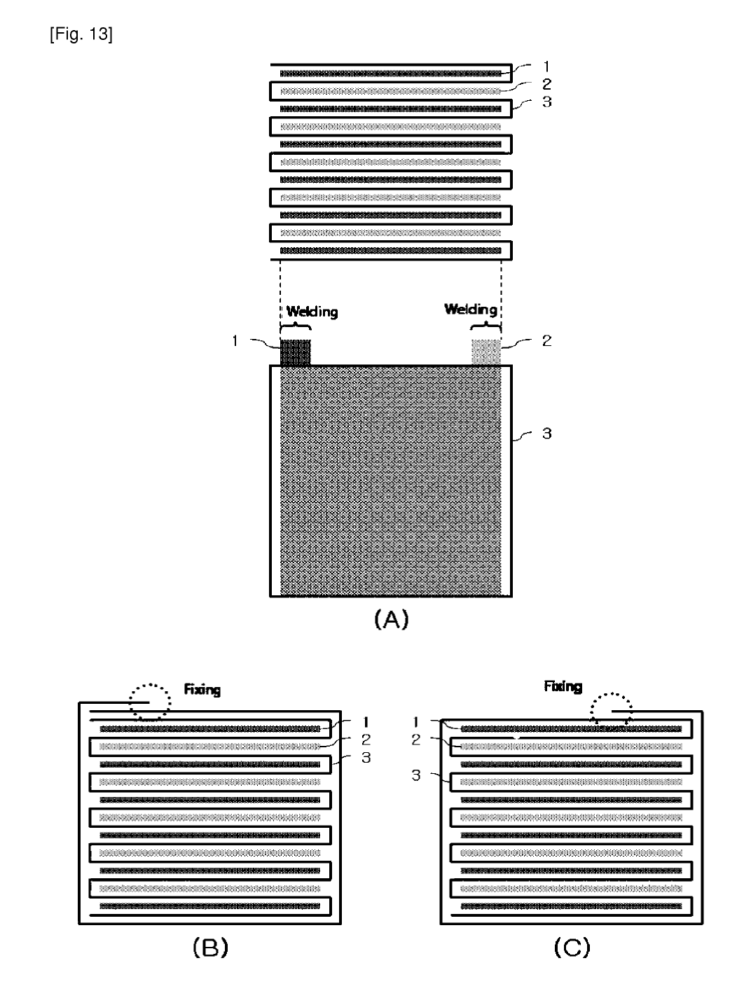

FIG. 13 shows a final process after the post treatment process in brief. As shown in FIG. 13 (A) in brief, in process g) after the process f), each tab of the anode plates 1 stacked in the first direction is welded to each other and each tab of the cathode plates 2 stacked in the first direction are welded to each other. Thus, the alignment state of each electrode plate stacked inside the cell stack stacked body may be securely fixed by welding each tab of the electrode plates.

As shown in FIG. 13 (B) in brief, in process h), a cell stack is completed by enclosing and fixing a circumference of the cell stack stacked body with the separator 3 in the first and second directions. An end portion of the separator 3 is fixed according to methods such as taping and heat pressure and the method is determined properly according to a product, a material, and a preparing environment. FIG. 13 (B) shows that the separator included in the cell stack stacked body and the separator enclosing the cell stack stacked body are separated to each other. This separation is completed by performing the enclosing process h) after cutting the separator 3 in the locations of the reference roller 11 of the top and the bottom in the process e) but it is not a necessary process. For example, as shown in FIG. 13 (C), it is possible to enclose the cell stack stacked body with the separator of the side, which is maintained without cutting after the process e), by remaining one side of the separator without cutting by cutting the separator 3 in the location of the reference roller 11 of only the top or the bottom in the process e). Selection of the processes is determined properly according to a product, a material, and a preparing environment and the present invention is not limited by FIG. 13.

It will be apparent that the invention is not limited to the embodiments and application fields are diverse. In addition, various changes and modifications may be made by those skilled in the art without deviating from the basic concept of the invention as set forth in the appended claims.

1. A secondary battery inner cell stack stacking apparatus that prepares a secondary battery inner cell stack comprising a separator folded in a zigzag shape, and an anode plate and a cathode plate that are alternately inserted and stacked in folded portions of the separator, wherein a plurality of anode plates and cathode plates are simultaneously inserted into an electrode insertion space after forming the electrode insertion space by folding the separator in the zigzag shape in advance.

2. The apparatus of claim 1, wherein the secondary battery inner cell stack stacking apparatus, comprises:
a separator supplying device supplying the separator in a first direction;
a pair of reference rollers separately fixed and arrayed in top and bottom locations of the secondary battery inner cell stack in a first direction to guide the separator;
first and second mandrel rows separately arrayed along a second direction with the separator as a center and formed to be movable in each of the second and third directions by separately arraying a plurality of mandrels at the same interval in a region between the pair of reference rollers in the first direction; and
first and second electrode supplying devices separately arrayed along the second direction with the separator as a center and formed to be movable in each of the second and third directions by separately arraying the anode plates or the cathode plates at the same interval in a region between the pair of reference rollers in the first direction,
wherein the second direction is a direction vertical to the first direction; and
the third direction is a direction vertical to the first and second directions.

3. The apparatus of claim 2, wherein in the secondary battery inner cell stack stacking apparatus,
the first electrode supplying device is arrayed in an outer side of the first mandrel row and the second electrode supplying device is arrayed in an outer side of the second mandrel row with the separator as a center in an initial location,
mandrels included in the first mandrel row and mandrels included in the second mandrel row are alternately arrayed in the first direction for alternate moving of the first mandrel row and the second mandrel row in the second direction,
one type of electrode plate selected from the anode plate and the cathode plate is arrayed in the first electrode supplying device in parallel with the mandrels of the first mandrel row in the first direction, and another type of electrode plate, which is not arrayed in the first electrode supplying device, is arrayed in the second electrode supplying device in parallel with the mandrels of the second mandrel row in the first direction.

4. The apparatus of claim 2, wherein the first and second mandrel rows and the first and second electrode supplying devices are integrally formed.

5. A secondary battery inner cell stack stacking method based on a secondary battery inner cell stack stacking apparatus according to claim 2, comprising:
forming an electrode insertion space by folding a separator in a zigzag shape;
simultaneously inserting a plurality of anode plates and cathode plates into an electrode insertion space.

6. A secondary battery inner cell stack stacking method based on a secondary battery inner cell stack stacking apparatus according to claim 2, comprising:
supplying a separator into a region of first and second mandrel rows by a separator supplying device;
alternately moving the first and second mandrel rows in a second direction to form the separator in a zigzag shape;
moving first and second electrode supplying devices in the second or a third direction to insert an anode plate or a cathode plate into an electrode insertion space formed on a left and a right, respectively, by folding the separator in a zigzag shape;
separating the first and second electrode supplying devices from the anode plate or the cathode plate and removing the first and second mandrel rows by moving the first and second mandrel rows in the third direction; and
cutting the separator in a location of a reference roller of a top or a bottom.

7. The method of claim 6, wherein the alternately moving of the first and second mandrel rows and the moving of first and second electrode supplying devices are simultaneously performed since the first and second mandrel rows and the first and second electrode supplying devices are integrally formed, wherein in the moving of first and second electrode supplying devices, the first and second electrode supplying devices move in the second direction.

8. The method of claim 6, wherein in the separating of the first and second electrode supplying devices, the first and second electrode supplying devices move in the second or third direction and are removed.

9. The method of claim 6, further comprising:
after the cutting of the separator,
performing a post treatment process including a pressing or heating process on a completed cell stack stacked body in the first direction.

10. The method of claim 9, further comprising:
after the performing of a post treatment process,
welding each tab of the stacked anode plates to each other in the first direction and welding each tab of the stacked cathode plates to each other in the first direction; and
enclosing and fixing a circumference of the cell stack stacked body in the first and second directions with the separator.
